(19) United States
(12) Patent Application Publication
(10) Pub. No.: US 2010/0141560 A1
(43) Pub. Date: Jun. 10, 2010

(54) Plasma Display Panel

(76) Inventors: Yoshiho Seo, Kawasaki (JP); Kazushige Takagi, Kawasaki (JP); Tadayoshi Kosaka, Kawasaki (JP); Hajime Inoue, Kawasaki (JP); Koichi Sakita, Kawasaki (JP); Tomoyuki Nukumizu, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/909,620

(22) PCT Filed: Mar. 25, 2005
(86) PCT No.: PCT/JP2005/005505

§ 371 Date: Sep. 25, 2007

(51) Int. Cl. G09G 3/28

(52) U.S. Cl. 345/60

(57) ABSTRACT

A plasma display device performing display control by utilizing plasma discharge includes a panel having a plurality of address electrodes and a plurality of display electrodes disposed to intersect with the address electrodes, and a drive circuit performing address discharge drive for selectively producing a discharge in cells between the address electrodes and the display electrodes, and display discharge drive for applying to the display electrode a display drive pulse having a voltage increasing with such a gradient as to continuously produce a discharge current in the selected cell. In the display discharge drive performed after the address discharge drive, a display drive pulse with an increasing voltage of gentle gradient is applied to the display electrode, thereby producing faint discharges continuously in the selected cell during the increase of the voltage applied to the display electrode. Display luminance is controlled by the above ramp-wave discharge. In such the ramp-wave discharge, differently from the conventional strong discharge, faint discharges are produced a plurality of times while the display drive pulse is being applied, enabling improvement on the discharge efficiency, and reduction of power consumption.

### FIELD OF THE INVENTION

The present invention relates to a plasma display device, and more particularly, a plasma display device driven by temporally separating an address period for selecting a light-on cell from a display discharge period for discharging to display at the selected light-on cell.

### BACKGROUND ARTS

A plasma display device (hereafter, PDP device) is constituted of a plasma display panel and a drive unit for driving electrodes in the panel. The PDP device currently in wide use is driven with an ADS method in which an address period for selecting a light-on cell is separated from a period for display discharge (or sustain discharge), discharge for displaying at the selected light-on cell.

FIG. 1 shows a diagram illustrating the electrode structure and the drive waveform of the conventional PDP. FIG. 1(A) shows the electrode structure in which X electrodes X0, X1 and Y electrodes Y0, Y1 are disposed in pairs in the horizontal direction, while address electrodes A0-A4 are disposed in the vertical direction in such a manner as to intersect with the X and Y electrodes.

FIG. 1(B) represents the drive waveform, in particular, the drive waveform at the display discharge (sustain discharge). In an address period not shown, the Y electrodes are successively scanned, and in synchronization with the above scanning of the Y electrodes, the light-on cell is selected by applying, or not applying, a voltage to the address electrode. Namely, if the voltage is applied to the address electrode while the Y electrode is driven, an address discharge arises between the Y electrode and the address electrode at the intersecting position. Next, in the display discharge shown in FIG. 1(B), by applying sustain discharge pulses Vx, Vy alternately to the X electrodes and the Y electrodes, a sustain discharge voltage is repeatedly applied between the X electrodes and the Y electrodes, so as that the sustain discharge is repeatedly produced only in the light-on cell in which wall charges are deposited by the address discharge.

As such, in the display discharge to generate luminance for display, by applying an alternating voltage between the X and Y electrodes and repeating sustain discharge, a luminance value is reproduced by the number of sustain discharge. In this case, when a voltage Vx sufficiently higher than a threshold voltage between the X and Y electrodes is applied to the X electrode, a strong discharge occurs only once from the X electrode to the Y electrode, and a discharge current Idis having a high peak flows from the X electrode toward the Y electrode. Among the pairs of electrons and ions produced by the strong discharge in the discharge space, electrons are accumulated on the X electrode i.e. positive electrode side, while ions are accumulated on the Y electrode i.e. negative electrode side, respectively, as wall charges. Because of the above produced wall charges, a voltage difference between the X and Y electrodes is extinguished, and thus discharge is not produced thereafter. Further, a subsequent discharge pulse in the reverse direction is applied between the X and Y electrodes, and also by use of the deposited wall charges, a strong discharge is produced in the reverse direction. As such, in the conventional PDP device, in response to one sustain discharge pulse, one strong discharge occurs in the display discharge, with a discharge current Idis having an extremely short width and a high peak value (a width of 200 ns, and a peak value of 100 A). In an ordinary display discharge period, sustain discharge pulses are applied for approximately 2,000 times per frame on the X and Y electrodes altogether. By controlling the number of times of the above sustain discharge pulses, the display having desired luminance is controlled.

Such the above-mentioned PDP device is described, for example, in Patent document 1.

Patent document 1: the official gazette of the Japanese Unexamined Patent Publication No. 2000-47635.

### DISCLOSURE OF THE INVENTION

### Problems to be Solved by the Invention

In case of the conventional display discharge using strong discharge, there is a problem as shown below. First, for one sustain discharge pulse, the strong discharge is produced only once, and therefore the discharge efficiency relative to the consumed power is not good. In order to obtain desired luminance, a large number of sustain discharge pulses have to be applied, which requires large consumption power. In other words, it is desired improve the discharge efficiency and reduce the number of sustain discharge pulses.

Secondly, because the display discharge is strong discharge, the peak value of the discharge current Idis is high. By this, a streaking phenomenon occurs because of the voltage drop at the X and Y electrodes caused by the above large discharge current. Here, the streaking phenomenon is such a phenomenon that an area having a larger number of cells being lit on becomes darker than an area having a smaller number of cells lit on, even when the luminance value is identical. Namely, different luminance values are produced depending on the display pattern. The above phenomenon is mainly caused by voltage drops produced at the X and Y electrodes due to a large discharge current. In the area having a larger number of cells lit on, the above voltage drop becomes larger, making the sustain discharge pulse voltage lower, and thus, the luminance becomes not so high. The streaking phenomenon brings about the degradation of image quality. In the example shown in FIG. 1, the peak value of the discharge current is 100 A. When considering that the mean current of the PDP device is approximately 2 A, it is understood how high the above peak value is.

Thirdly, because the display discharge is strong discharge, after the sustain discharge pulses are applied for a plurality of times, wall charges are kept to be deposited in a cell area. Moreover, the above wall charges in between a light-on cell and a light-off cell come into different states, with a variety of polarity states of the wall charges even among the light-on cells. Therefore, after the display discharge period and before the address period, a reset discharge is performed, by which the entire panel surface is discharged to put the entire cells into an identical state. The above reset discharge produces illumination (background illumination) in other than the display period, causing degradation in the image quality of black display. This also causes degraded image quality.

Accordingly, it is an object of the present invention to provide a PDP device, having reduced power consumption with improved discharge efficiency.

It is another object of the present invention to provide a PDP device having improved image quality.

### Means to Solve the Problem

According to a first aspect of the present invention to achieve the aforementioned objects, a plasma display device performing display control by utilizing plasma discharge includes: a panel having a plurality of address electrodes and a plurality of display electrodes disposed to intersect with the address electrodes; and a drive circuit performing address discharge drive for selectively producing a discharge in a cell between each of the address electrodes and the display electrodes, and display discharge drive for applying to the display electrode a display drive pulse having a voltage increasing with such a gradient as to continuously produce a discharge current in the selected cell.

According to a second aspect of the present invention to achieve the aforementioned objects, a plasma display device performing display control by utilizing plasma discharge includes: a panel having a plurality of address electrodes and a plurality of display electrodes disposed to intersect with the address electrodes; and a drive circuit performing address discharge drive for selectively producing a discharge in a cell between each of the address electrodes and the display electrodes, and display discharge drive for applying to the display electrode a display drive pulse having a voltage increasing with such a gradient as to continuously produce faint discharges in the selected cell.

According to the above first or the second aspect, in the display discharge drive performed after the address discharge drive, a display drive pulse having an increasing voltage of gentle gradient is applied to the display electrode. By this, faint discharges are continuously produced in the selected cell while the voltage applied to the display electrode is increasing. By the above ramp-wave discharge, display luminance is controlled. In such the ramp-wave discharge, differently from the conventionally used strong discharge, a plurality of times of faint discharges are produced while the display drive pulse is being applied. By this, improvement of the discharge efficiency and reduction of the power consumption can be attained. Moreover, because of no generation of such a discharge current of high peak value as in the conventional strong discharge, and an instantaneous discharge current value is lowered, the streaking phenomenon is reduced. Also, in the ramp-wave discharge during the display discharge, the entire light-on cells come to an identical state at the time of completion of the discharge. This makes it unnecessary to perform reset discharge of the entire panel surface prior to the subsequent address discharge drive. Therefore, background illumination can be reduced.

In a preferred embodiment of the aforementioned first and second aspects, the above display panel includes a first display electrode and a second display electrode mutually disposed in parallel, as display electrodes. Further, in the address discharge drive, the drive circuit applies an address voltage to the address electrode, while successively driving one of the first and the second display electrodes, and in the display discharge drive, the drive circuit applies the above display drive pulse between the first and the second electrodes.

In a preferred embodiment of the aforementioned first and second aspects, the display panel includes a first display electrode and a second display electrode disposed mutually adjacently, as display electrodes. In the address discharge drive, the drive circuit applies an address voltage to the address electrode, while successively driving one of the first and the second display electrodes. Further, in the display discharge drive, the drive circuit performs a first display discharge drive for applying the display drive pulse between the first and the second display electrodes, and performs a second display discharge drive for applying the display drive pulse between the first or the second display electrode and the address electrode. By the second display discharge drive, the wall charges deposited on the address electrode can be removed.

In a preferred embodiment of the aforementioned first and second aspects, the above drive circuit performs the address discharge drive and the display discharge drive subsequent thereto, repeatedly for a plurality of times. Since ramp-wave discharge occurs in the display discharge drive, it is not necessary to perform a reset discharge for resetting the entire panel surface prior to the subsequent address discharge drive.

In a preferred embodiment of the aforementioned first and second aspects, the drive circuit performs the address discharge drive and the display discharge drive subsequent thereto repeatedly for a plurality of times, and a final voltage value of the display drive pulse in each display discharge drive is weighted by a predetermined ratio. The display drive pulse in each display discharge drive has an increasing voltage of a predetermined gradient. Accordingly, by increasing the final voltage value of the above display drive pulse, the scale of each faint discharge can be increased, and the luminance value by the ramp-wave discharge can be enhanced. Thus, by repeating the address discharge drive, as well as the display discharge drive subsequent thereto, for a plurality of times, and by weighting the final voltage value of the display drive pulse in each display discharge drive, for example, by a binary ratio of 1:2:4 or the like, it is possible to perform luminance display in multiple gray scales.

According to a third aspect of the present invention to achieve the aforementioned objects, a plasma display device performing display control by utilizing plasma discharge includes: a panel having a plurality of address electrodes and a plurality of display electrodes disposed to intersect with the address electrodes; and a drive circuit performing address discharge drive for selectively producing a discharge in a cell between each of the address electrodes and the display electrodes, and display discharge drive for applying to the display electrode a display drive pulse having a voltage increasing with such a gradient as to continuously produce a discharge current in the selected cell. Further, in a frame period, there are included a plurality of subframe periods in which the address discharge drive and one-time display discharge drive subsequent thereto are performed, respectively, and in each of the plurality of subframe periods, the drive circuit selects a light-on cell by the address discharge drive, and controls the luminance value of each cell in the frame period.

According to the above-mentioned third aspect, the frame period is constituted of a plurality of subframe periods, and in each subframe period, an address discharge drive and a one-time display discharge drive are performed. Because each the display discharge drive is ramp-wave discharge, the discharge efficiency is increased, and also, it becomes unnecessary to perform a reset drive of the entire panel surface after the display discharge drive, and the background illumination can be reduced accordingly.

In a preferred embodiment of the aforementioned third aspect, the drive circuit weights the final voltage values of a display drive pulse in the display discharge drives by a predetermined ratio. This enables luminance display in multiple tones.

### EFFECTS OF THE INVENTION

According to the invention, because the display discharge is performed by use of ramp-wave discharge, it is possible to improve the discharge efficiency and reduce power consumption. Also, it is possible to reduce the peak current value of the display discharge.

Further scopes and features of the present invention will become more apparent by the following description of the embodiments with the accompanied drawings.

### BRIEF DESCRIPTION OF THE DRAWINGS

FIG. 1 shows diagrams illustrating the electrode structure and the drive waveform of the conventional PDP.

FIG. 2 shows diagrams illustrating the structure of the PDP device and the display discharge waveform, according to an embodiment of the present invention.

FIG. 3 shows detailed configuration diagrams of the display panel of a PDP device according to the present embodiment.

FIG. 4 shows a diagram illustrating a first exemplary drive waveform according to the present embodiment.

FIG. 5 shows a diagram illustrating a second exemplary drive waveform according to the present embodiment.

FIG. 6 shows a diagram illustrating a third exemplary drive waveform according to the present embodiment.

FIG. 7 shows a waveform in one subframe period of the first exemplary drive waveform.

FIG. 8 shows diagrams illustrating the voltage transition of the light-on cell and the light-off cell when driven with the third drive waveform.

FIG. 9 shows diagrams illustrating the transition of the wall charges in the display panel when driven with the third drive waveform.

FIG. 10 shows a table in which an embodiment of the display discharge drive, using ramp-wave discharge with the drive waveform shown in FIG. 7, is compared with an example of the display discharge drive according to the conventional drive method, using strong discharge.

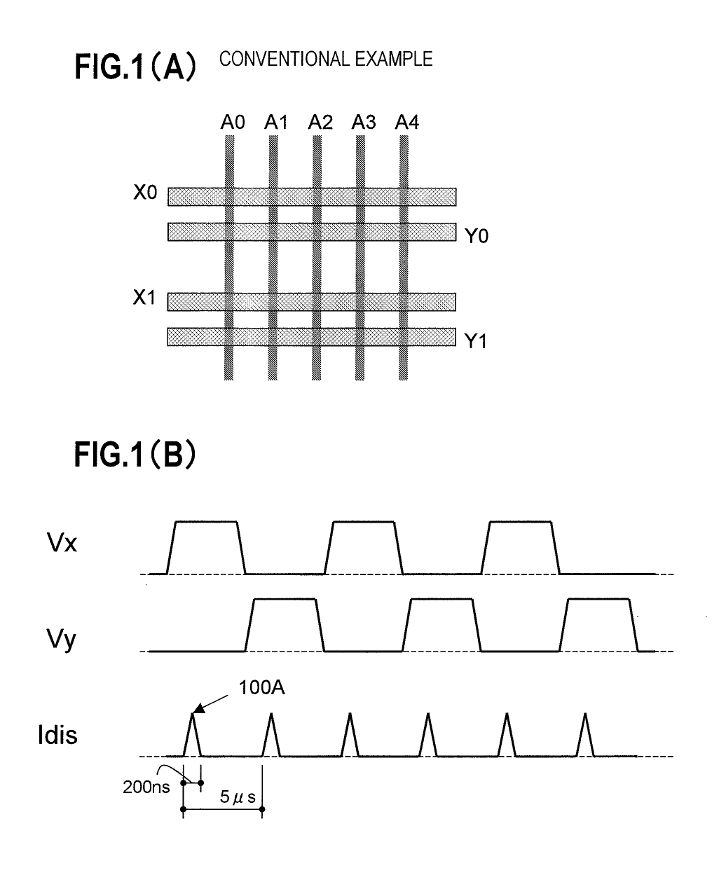

### EXPLANATION OF THE REFERENCE SYMBOLS

A0-A4: address electrodes, Y0, Y1: scan electrodes (Y electrodes), X0, X1: sustain electrodes (X-electrodes), PAN: display panel, DRx, DRy, DRa: drive circuit group.

### DETAILED DESCRIPTION OF THE PREFERRED EMBODIMENTS

The preferred embodiment of the present invention is described hereinafter referring to the charts and drawings. However, it is to be noted that the scope of the present invention is not limited to the embodiments described below, but instead embraces all items described in the claims and equivalents thereof.

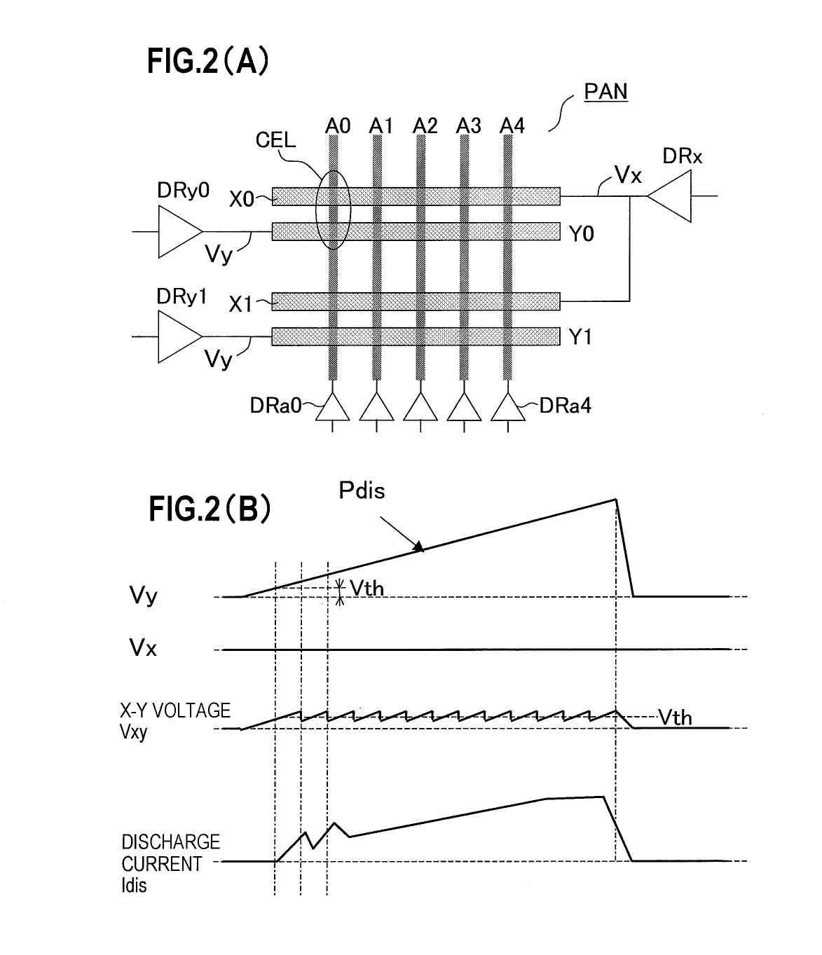

FIG. 2 shows diagrams illustrating the structure of the PDP device and the display discharge waveform, according to an embodiment of the present invention. The PDP device shown in FIG. 2(A) includes a display panel PAN and a drive circuit group DRa, DRx, Dry0 and Dry1. The display panel PAN includes display electrodes constituted of X electrodes X0, X1 and Y electrodes Y0, Y1 being disposed in the horizontal direction, and also address electrodes A0-A4 being disposed in the vertical direction. A cell area CEL is formed at the intersection position of an X, Y electrode pair and each address electrode. Also, the drive circuit group includes address drivers DRa0-DRa4 for driving the address electrodes, Y drivers DRy0-DRy1 for driving the Y electrodes, and an X driver DRx for commonly driving the X electrodes. With the above drive circuit group, the following drive is performed to each electrode.

According to the display discharge waveform shown in FIG. 2(B), in a display discharge drive following an address discharge drive, the Y driver DRy applies the aforementioned display discharge pulse Pdis to a Y electrode, while the X driver DRx sustains an X electrode to a predetermined voltage. Or, in the address discharge, by reversing the X electrode and the Y electrode, the X driver DRx applies to the X electrode the display discharge pulse Pdis having a voltage increasing with a predetermined gradient, while the Y driver DRy sustains the Y electrode to a predetermined voltage. Alternatively, the both drivers DRx and DRy apply pulses respectively to the X and Y electrodes so that the display discharge pulse Pdis is applied therebetween.

Prior to the display discharge drive, the address discharge drive is performed, and thereby the address discharge has been produced to the selected cell. The above address discharge is identical to the address discharge performed in the prior art. Therefore, wall charges are deposited on the dielectric layers of the address electrode and the Y electrode of the light-on cell on which the address discharge has been produced. Then, when the aforementioned display discharge pulse Pdis is applied to the X and Y electrodes, ramp-wave discharge occurs on the light-on cell on which the wall charges have been deposited.

Differently from the conventional strong discharge, the above ramp-wave discharge is a discharge to produce faint discharges substantially continuously, by applying the discharge pulse Pdis, having a gradually ascending voltage, between the electrodes on which discharge is to be produced. Because of the continuous occurrence of the faint discharges, a discharge current is continuously produced on the display electrode.

In FIG. 2(B), there are shown applied voltages Vx, Vy, which are applied to the X and Y electrodes by the drivers DRx and DRy, and a voltage Vxy between the X and Y electrodes in the cell area. Also, a discharge current Idis produced on the X and Y electrodes by the ramp-wave discharge is shown. When the display discharge pulse Pdis is applied by the drivers DRx and DRy, the voltage Vxy between the X and Y electrodes increases in the cell area. Because the voltage has a gently increasing gradient, when the voltage exceeds a discharge threshold Vth, a discharge occurs for a while. Because of the occurrence of faint discharge, wall charges are deposited in the area in which the above discharge is produced. By this, the voltage Vxy between the X and Y electrodes in the area of interest becomes lower than the threshold voltage, causing the suspension of the discharge. Namely, the occurrence of the faint discharge is suspended. However, the voltage of the display discharge pulse Pdis is further increasing, the voltage Vxy between the X and Y electrodes of the cell area exceeds the threshold voltage again, and thus the discharge occurs. In this case also, because of being suspended due to the wall charges, the discharge is faint discharge. As such, by gradually increasing the voltage value of the display discharge pulse Pdis, the faint discharge continuously occurs. In the above case, the voltage Vxy between the X and Y electrodes merely ascends and descends in the vicinity of the threshold voltage.

With the ramp-wave discharge described above, the discharge current Idis produced on the X and Y electrodes is also produced intermittently. By the mutually overlapped discharge current caused by the faint discharges continuously produced, it is confirmed as if a predetermined discharge current were produced continuously. The discharge current Idis shown in FIG. 2 gradually increases from the initial faint discharge. The reason is as follows. The X electrode and the Y electrode are disposed closely in the cell area CEL, and in the areas of the both electrodes, there are an area located most closely, and an area located farther. Accordingly, when the application of the display discharge pulse Pdis is started, first, discharge occurs between the closest areas of the both electrode areas because of exceeding the threshold voltage. Further, when the voltage of the display discharge pulse Pdis increases more, not only in between the closest areas, discharge also occurs between the surrounding areas apart therefrom because of exceeding the threshold voltage (which is higher than the threshold voltage between the closest areas). In other words, the discharge area expands more, and a discharge current also increases. As such, the area in which the faint discharge occurs is gradually expanded in the X and Y electrode areas, and thus, the discharge current Idis increases, as shown in FIG. 2(B).

In the present embodiment, the display discharge by the ramp-wave discharge by applying the above-mentioned display discharge pulse has the following merits. First, in response to the application of a single display discharge pulse, because a plurality of times of faint discharges continuously occur, the discharge efficiency to the drive power supplied to the display electrode is enhanced as compared to the conventional strong discharge. Also, because alternating pulses having alternately changing polarities as in the conventional strong discharge are not applied between the display electrodes, there is no need of charging and discharging the capacity between the electrodes, which reduces ineffective power. Thus, the power consumption can be reduced. Secondly, by use of the ramp-wave discharge, only a small discharge current continues through the continuous occurrence of the faint discharges, and the peak value of the discharge current remarkably decreases accordingly. By this, the voltage drop between the X and Y electrodes is reduced, which leads to the reduction of the streaking phenomenon. Further, thirdly, in the ramp-wave discharge, the voltage Vxy between the X and Y electrodes in the cell area is sustained in the vicinity of the discharge threshold voltage. Moreover, only one time of the ramp-wave discharge is carried out after the address discharge. Therefore, at the time point of the completion of the display discharge drive, the X and Y electrodes of the light-on cell are in a state of having wall charges corresponding to the threshold voltage difference. The above state is equivalent to the wall charge state in the light-off cell at the time point of the completion of the address discharge drive, and there is no such a large amount of deposition of wall charges as produced in the conventional strong discharge. Therefore, without reset discharge of the entire panel surface, it is possible to shift to a subsequent address discharge drive. Namely, the reset discharge of the entire panel surface becomes unnecessary, and the background illumination caused therefrom can be avoided.

As described above, differently from the display discharge utilizing the strong discharge in the conventional display drive, by performing the display discharge drive utilizing the ramp-wave discharge according to the present embodiment, the reduction of the power consumption and the improvement of the image quality can be realized.

Conventionally, in the reset discharge of the entire panel surface, there has also been carried out ramp-wave discharge, applying reset pulses having gradually increasing voltages. Namely, the reset pulses enabling ramp-wave discharge are applied to the entire cells, so as to put the wall charge states of the entire cells into the states in the vicinity of the threshold voltage at the subsequent address discharge drive. However, conventionally, in the display discharge drive after the address discharge drive, a sharp sustain discharge pulse has been applied to produce strong discharge.

Also, according to Patent document 1 mentioned earlier, as a sustain discharge pulse, a waveform having a voltage value gradually increasing from the vicinity of a minimum discharge sustain voltage value of a unit illumination area is applied. By applying such the sustain discharge pulse, a discharge between the X and Y electrodes is continued. However, in the Patent document 1, the sustain discharge pulses of inverse polarity are alternately applied between the X and Y electrodes. Accordingly, at the time of completion of each sustain discharge pulse, sufficient wall charges are produced on the X and Y electrodes by the strong discharge. With this, selective sustain discharge has been realized by applying the sustain discharge pulses of inverse polarity. Namely, in the PDP described in Patent document 1, a plurality of sustain discharge pulses are alternately applied in the display discharge drive after the address discharge drive. In contrast, according to the present embodiment, in the display discharge drive subsequent to the address discharge drive, only one time of discharge drive pulse is applied to produce the ramp-wave discharge. Thus, the reset discharge of the entire panel surface is not needed.

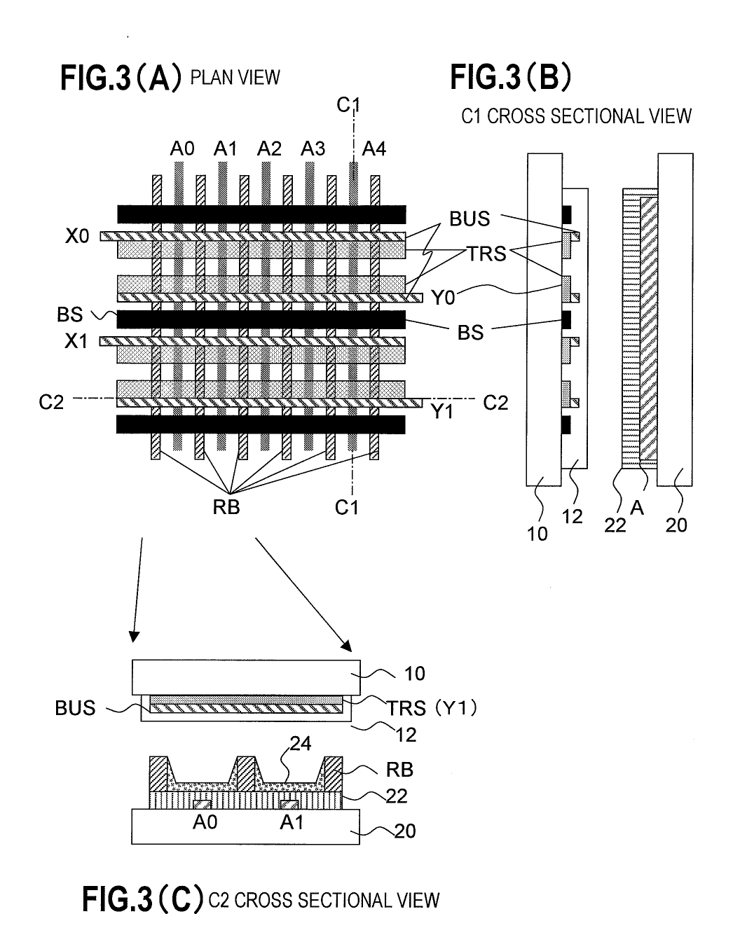

FIG. 3 shows detailed configuration diagrams of the display panel of a PDP device according to the present embodiment. There are shown plan view (A), C1 cross sectional view (B) and C2 cross sectional view (C). In the display panel, a front substrate 10 and a rear substrate 20 are disposed oppositely at the distance of a discharge space. On front substrate 10, there are provided X electrodes X0, X1 along display lines in the horizontal direction, and Y electrodes Y0, Y1 disposed adjacent thereto. The above X and Y electrodes are coated by dielectric layers 12. Each of the X and Y electrodes is formed of a transparent electrode TRS, and a Cr/Cu/Cr three-layered bus electrode BUS overlaid thereon. Further, between the X and Y electrode pairs, a black stripe BS is disposed to shield a phosphor 24 of rear substrate 20. On rear substrate 20, there are provided address electrodes A0-A4 extending in the direction perpendicular to the display lines, dielectric layer 22 for coating the above address electrodes A0-A4, ribs RB for demarcating each cell area, and phosphor layers 24 overlaid on dielectric layer 22 and the ribs RB.

Then, as to the drive of the above display panel, an address discharge is produced selectively in each cell area by successively scanning the Y electrodes Y0, Y1, which are scanning electrodes, and by driving an address electrode A in synchronization with the above scanning timing. With this, in the cell being selected and lit on, wall charges are deposited on dielectric layers 12, 22. Thereafter, the aforementioned display discharge pulse is applied between the X and Y electrodes, so as to produce ramp-wave discharge. The above display discharge pulse has a polarity directing from one of the X and Y electrodes to the other, corresponding to the polarity of the address discharge. Here, the display discharge pulse is applied only once, without an alternating voltage of inverted polarities applied between the X and Y electrodes.

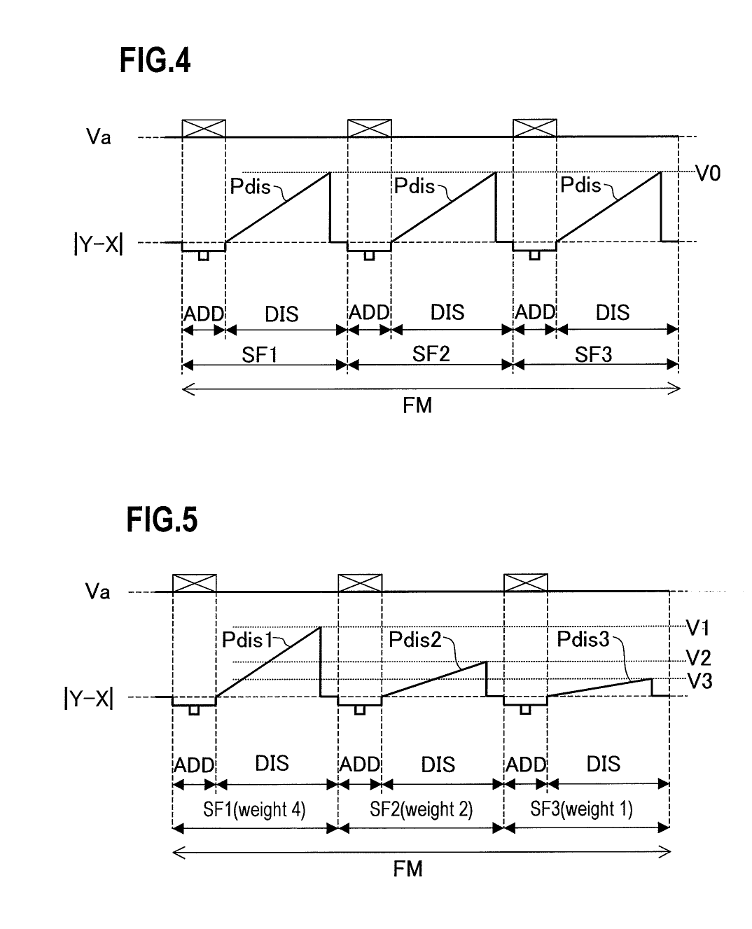

FIG. 4 shows a diagram illustrating a first exemplary drive waveform according to the present embodiment. In this example, three (3) subframe periods SF1-SF3 are assigned in one frame period FM. Each of the three subframe periods has an identical waveform and an identical time period. In each subframe period SF1-SF3, first, an address discharge drive ADD is performed. Namely, Y electrodes are successively scanned, and in synchronization therewith, a voltage Va is applied to the address electrode corresponding to a light-on cell. By this, an address discharge is produced in the selected cell. Next, a display discharge drive DIS is performed. In the display discharge drive DIS, one display discharge pulse Pdis having a gradually increasing voltage is applied between the entire X and Y electrodes. The gradient of the above voltage increase is identical to the gradient described earlier. By the application of the above display discharge pulse Pdis, in the light-on cell, the aforementioned ramp-wave discharge occurs between the X and Y electrodes. Further, the final voltage value V0 of the display discharge pulse Pdis is limited to a level not to produce ramp-wave discharge in non-selected light-off cells. More specifically, since wall charges caused by the address discharge are disposed in the selected cell, the voltage by the above wall charges is added to the voltage caused by the display discharge pulse Pdis. Thus, ramp-wave discharge occurs between the X and Y electrodes of the selected cell. On the other hand, wall charges are not deposited in the non-selected cell, and accordingly, even when the final voltage V0 of the display discharge pulse Pdis is applied thereto, discharge does not occur.

In the exemplary drive waveform shown in FIG. 4, each display discharge pulse Pdis having an identical terminating voltage V0 and an identical period is applied throughout the entire subframe periods SF1-SF3. Accordingly, a display having an identical luminance value is made throughout the entire subframe periods. Therefore, by selecting any subframe period(s) and lighting on, it is possible to represent four gray scales with the combination of at least three subframes.

FIG. 5 shows a diagram illustrating a second exemplary drive waveform according to the present embodiment. In this example also, three subframe periods SF1-SF3 are assigned in one frame period FM. Although the three subframe periods have an identical time period, final voltages V1, V2, V3 are different. In the present example, V1:V2:V3=4:2:1 is held. Accompanying this, each gradient of display discharge pulses Pdis1, 2, 3 in each subframe is made lower in that order. Also, each final voltage V1, V2, V3 is limited to such an extent that discharge does not occur in the light-off cells.

In the second exemplary discharge waveform also, one frame period FM includes three subframe periods SF1-SF3, and an address discharge drive ADD and a display discharge drive DIS are performed in each subframe period. The address discharge drive is similar to the address discharge drive described above. Further, in the display discharge drive DIS, the inclination of the display discharge pulse Pdis1 in the first subframe period SF1 has such a gradient as to continuously produce faint discharge between the X and Y electrodes, but not to produce strong discharge. Further, in the first subframe period SF1, the display discharge pulse Pdis1 having the largest inclination is applied, and therefore, a luminance of a weight value 4 is obtained. Next, in the second subframe period SF2, the inclination of the display discharge pulse Pdis2 has such a gradient as to produce ramp-wave discharge, similarly to the pulse Pdis1. Here, because the pulse rises with such a gradient to make the final voltage V2, the scale of the faint discharge in the ramp-wave discharge comes to approximately ½ as large as in the first subframe period SF1. Accordingly, the luminance value becomes half. Then, in the third subframe period SF3, the inclination of the display discharge pulse Pdis3 has such a gradient as to produce ramp-wave discharge, similarly to the pulse Pdis1. Here, because the final voltage V3 is the smallest, the scale of the faint discharge in the ramp-wave discharge is the smallest. Accordingly, the luminance value becomes approximately ¼ as large as the luminance value produced in the first subframe period SF1.

As such, in the second exemplary drive waveform, a different luminance value (luminance value having a binary weight of 4:2:1) is displayed by making a different inclination of the display discharge pulse Pdis in each subframe period. Accordingly, by properly selecting a cell to be lit on in each subframe period using address discharge, it is possible to display luminance values of eight gray scales in each cell.

In the drive waveforms shown in FIG. 4 and FIG. 5, the address discharge ADD and the display discharge drive DIS are carried out in repetition. Moreover, in the display discharge drive DIS after the address discharge drive ADD, one display discharge pulse is applied between the X and Y electrodes, so as to produce the ramp-wave discharge. Further, in each subframe, the reset discharge of the entire panel surface is not performed. Since the voltage between the X and Y electrodes is reset to a threshold voltage state due to the ramp-wave discharge, the reset discharge of the entire panel surface is not necessary.

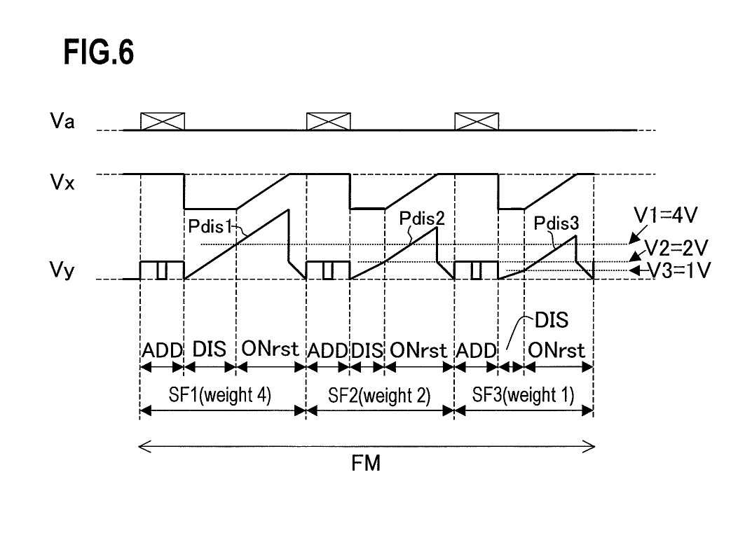

FIG. 6 shows a diagram illustrating a third exemplary drive waveform according to the present embodiment. In FIG. 6, there are shown address voltage Va applied to the address electrode, X voltage Vx applied to the X electrode, and Y voltage Vy applied to the Y electrode. In the exemplary third drive waveform, the frame period FM includes three subframe periods SF1-SF3. Also, each subframe period SF1-SF3 includes an address discharge drive ADD and display discharge drives DIS and ONrst. In the present example, the display discharge drives are formed of a first display discharge drive DIS between the X and Y electrodes, and a second display discharge drive ONrst between the Y electrode and the address electrode and between the X and Y electrodes. The operation thereof will be described later in detail.

Now, the display discharge pulses in the display discharge drive have mutually different final voltages V1, V2, V3 (V1:V2:V3=4:2:1) in the first display discharge drive DIS between the X and Y electrodes, and have the identical waveform in the second display discharge drive ONrst between the Y electrode and the address electrode and between the X and Y electrodes. In the first display discharge drive DIS between the X and Y electrodes, by use of mutually different final voltages V1, V2, V3, thereby making mutually different pulse gradients, displays of different luminance values are realized. With this, by combining three subframes, display control of 8 gray scales can be attained.

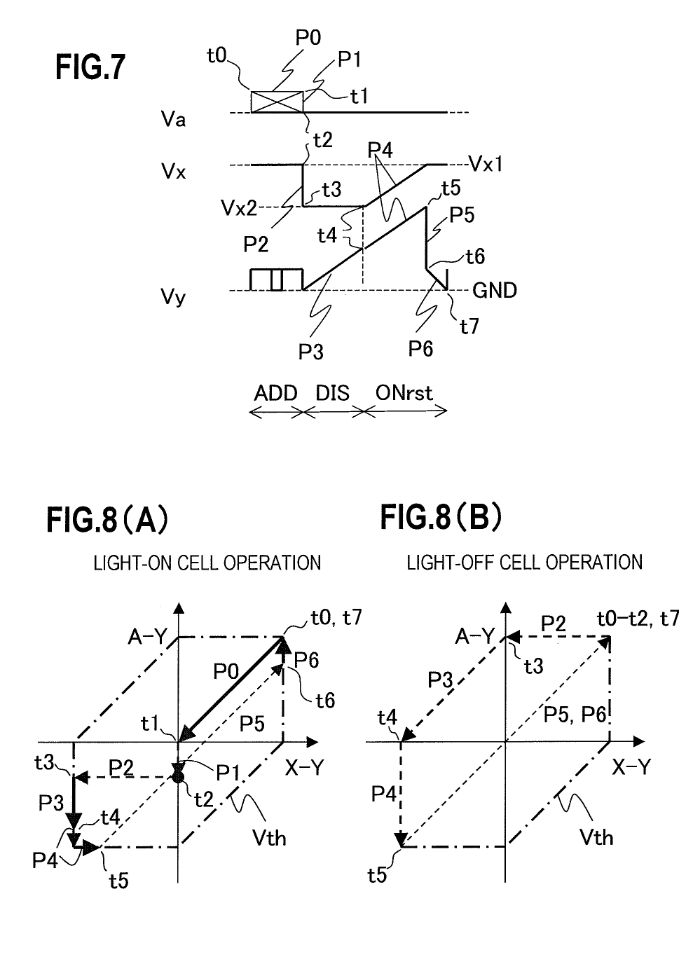

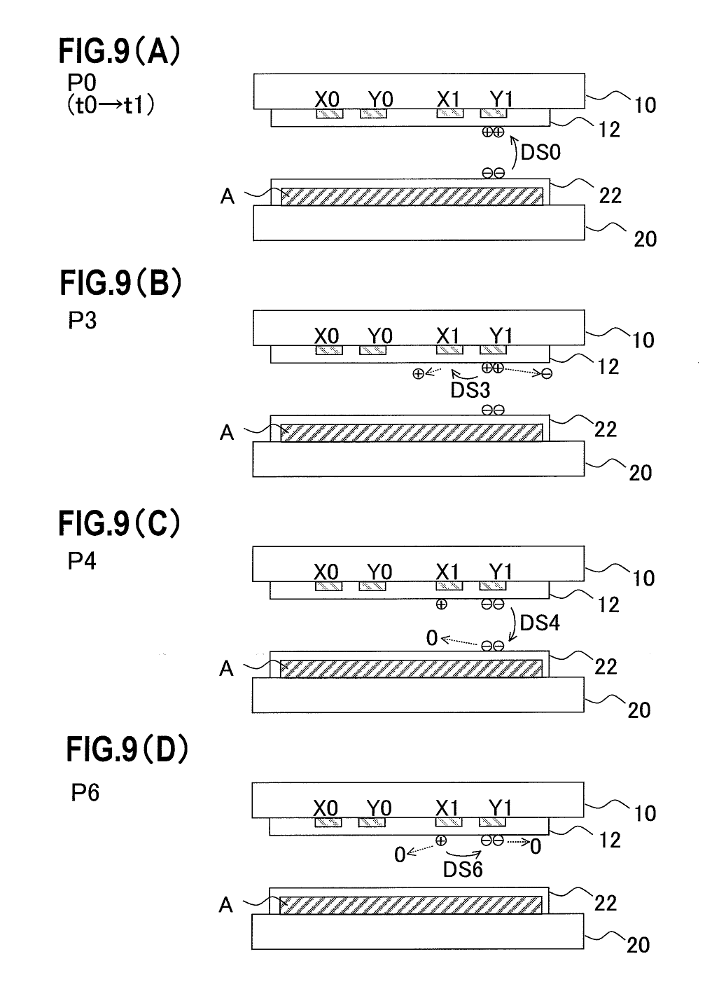

FIG. 7 shows a waveform in one subframe period of the third exemplary drive waveform. Also, FIG. 8 shows diagrams illustrating the voltage transition of the light-on cell and the light-off cell when driven with the third drive waveform. Further, FIG. 9 shows diagrams illustrating the transition of the wall charges in the display panel when driven with the third drive waveform. Referring to the above figures, the discharge operation in the exemplary third drive waveform will be described below.

According to the drive waveform shown in FIG. 7, the process is divided into the following processes: process P0 (process from t0 to t1) in which the address voltage Va is applied; process P2 (process from t2 to t3) in which an X voltage Vx is lowered from a predetermined level Vx1 to a Vx2; process P3 (process from t3 to t4) in which a Y voltage Vy gradually increases from the ground level to a certain level, while the X voltage Vx is maintained to a predetermined level Vx2; and thereafter, process P4 (process from t4 to t5) in which both the X voltage Vx and the Y voltage Vy increase; process P5 (process from t5 to t6) in which, while the X voltage Vx is maintained to the predetermined level Vx1, the Y voltage Vy is lowered; and process P6 (process from t6 to t7) in which the Y voltage Vy is gradually lowered. In the light-on cell, discharges are produced in the processes P0, P3, P4 and P6.

In FIG. 8, there are shown the transitions through processes P0-P6 in regard to the voltage X-Y between X and Y (horizontal axis) and the voltage A-Y between the address and Y (vertical axis) in the light-on cell and the light-off cell. In FIG. 8, solid lines denote the processes in which discharge occurs, while broken lines denote the processes in which discharge does not occur. Also, in FIG. 8, single-dotted chain lines denote a closed curve of a threshold voltage Vth between X and Y and between the address and Y. As described earlier, in the ramp-wave discharge, faint discharge is produced when the voltage between the electrodes exceeds the threshold voltage Vth, and a voltage between the both electrodes is maintained near the threshold voltage. Therefore, by showing the shifts of the above voltage together with the closed curve of the threshold voltage, it is possible to easily understand the discharge operation in the cells.

In FIG. 9, there are shown the cross sectional views of front substrate 10 and rear substrate 20, and the discharge operation in processes P0, P3, P4 and P6. It is assumed that an X electrode X1 and a Y electrode Y1 correspond to a light-on cell, while an X electrode X0 and a Y electrode Y0 correspond to a light-off cell.

First, at the address discharge drive ADD, in process P0, when the address voltage Va is raised to a positive voltage at the timing the Y voltage Vy is lowered, an address discharge DS0 is produced in the light-on cell of the above intersecting position. Namely, a strong discharge is produced from the address electrode A toward the Y electrode Y1 of the light-on cell. Thus, negative charges are accumulated on the address electrode A, while positive charges are accumulated on the Y electrode Y1, as wall charges, respectively. On the other hand, in the light-off cell, neither discharge is produced nor wall charges are accumulated.

In the light-on cell, at state t0, the X-Y voltage is in the level of the threshold voltage Vth, and also the A-Y voltage is in the level of the threshold voltage Vth. Now, in process P0, when the Y voltage Vy is lowered and the A voltage Va is raised, the A-Y voltage exceeds the threshold voltage, and the strong discharge is produced accordingly. As a result, at state t1, wall charges are accumulated on the address electrode and the Y electrode, and the A-Y voltage becomes zero. Similarly, by the accumulation of negative charges on the Y electrode, the X-Y voltage also becomes zero. In the light-off cell, the voltage state does not change because of non-occurrence of discharge in process P0.

Next, in process P1 (t1-t2), when the A voltage Va is lowered and the Y voltage Vy is raised, in the light-on cell, the A-Y voltage is lowered at t2. In the light-off cell, there is no change in the A voltage Va, nor in the Y voltage Vy.

Next, the process is shifted to the display discharge drive DIS. In process P2 (t2-t3), the X voltage Vx is lowered from a voltage Vx1 to Vx2. With this, in both the light-on cell and the light-off cell, the X-Y voltage is shifted by the amount of -Vth. Namely, at t3, the X-Y voltage comes to -Vth in the light-on cell, and comes to 0 V in the light-off cell.

Then, in process P3 (t3-t4), the Y voltage Vy is gradually increased, while the X voltage Vx is maintained to Vx2. With this, in the light-on cell, a ramp-wave discharge DS3 (FIG. 9(B)) is produced from the Y electrode Y1 toward the X electrode X1. In the light-off cell, since wall charges are not accumulated, the ramp-wave discharge is not produced. As shown in the light-on cell operation of FIG. 8(A), when the Y voltage Vy increases from the position of t3, both the X-Y voltage and the A-Y voltage are shifted to the negative direction. However, in the light-on cell, faint discharges are continuously produced by the ramp-wave discharge. As a result, the X-Y voltage is maintained near the threshold voltage Vth. On the other hand, as shown in the light-off cell operation of FIG. 8(B), both the X-Y voltage and the A-Y voltage are shifted to the negative direction from the position of t3. By the above ramp-wave discharge DS3, negative charges on the Y electrode Y1 and positive charges on the X electrode X1 are accumulated, respectively (see FIG. 9(C)).

Next, the process is shifted to the on-reset drive ONrst, the latter half of the display discharge drive. In process P4 (t4-t5), both the Y voltage Vy and the X voltage Vx are gradually increased without changing the X-Y voltage. With the ascent of the Y voltage Vy, the A-Y voltage is decreased, and in the course of time, the A-Y voltage in the light-on cell exceeds the threshold voltage -Vth, thus producing a ramp-wave discharge DS4 from the Y electrode Y1 toward the address electrode A. By the above ramp-wave discharge, the negative charges accumulated on the address electrode A are neutralized and reset by the positive charges. Also, by the ramp-wave discharge DS4 in process P4, negative charges increase on the Y electrode Y1, and the X-Y voltage approaches zero to some extent. Further, in the light-off cell, only the decrease of the A-Y voltage occurs.

The Y voltage Vy increases in process P4, but the final voltage thereof is limited so as not to exceed the threshold voltage between Y and A of the light-off cell. The reason is that the ramp-wave discharge will occur in the light-off cell if the final voltage exceeds the above threshold voltage.

Next, in process P5 (t5-t6), the Y voltage Vy is lowered drastically. With this, the polarities of the X-Y voltages in both the light-on cell and the light-off cell are reversed. However, the above reversed polarities are made within a range not exceeding the threshold voltage Vth, and no discharge is produced in any cells accordingly.

Finally, in process P6 (t6-t7), when the Y voltage Vy is gradually lowered, the X-Y voltage increases, and also the A-Y voltage increases. Then, at t6, the X-Y voltage is in the threshold voltage level. By lowering the above Y voltage Vy, a ramp-wave discharge DS6 is produced in the light-on cell from the X electrode X1 toward the Y electrode Y1, and thus, the voltage between the both electrodes is maintained to the threshold level. Meanwhile, the A-Y voltage increases and returns to the original position of t0 at t7. Namely, both the X-Y voltage and the A-Y voltage are restored to the original state (t0) having the difference of the threshold voltage.

As described above, in the display discharge drives DIS, ONrst, illumination is produced to have a predetermined luminance value by the ramp-wave discharge between X and Y in the first-half drive DIS. Further, in the latter-half reset drive ONrst, both the wall charges on the address electrode A and the wall charges on the X, Y electrode produced in the light-on cell are reset by the ramp-wave discharges DS4, DS6. In the above reset discharge also, illumination is produced to have a predetermined luminance. Accordingly, a luminous amount by the entire ramp-wave discharges DS3, DS4, DS6 becomes the luminance value in the subframe concerned.

Then, at the time of completion of the display discharge drive DIS, ONrst, in both the light-on cell and the light-off cell, the voltages between the X-Y electrodes and between the A-Y electrodes are restored to the threshold levels. Therefore, it is not necessary to reset the entire panel surface prior to the address discharge drive in the next subframe.

The drive method shown in FIGS. 7, 8 and 9 is an exemplary case of using a triple-electrode surface-discharge type display panel shown in FIG. 3. In case of a different electrode structure, it is necessary to apply a different drive waveform, needless to say. Even in such a case, by applying a display discharge pulse producing ramp-wave discharge to a sustain electrode in the display discharge drive after the address discharge drive, at the time of completion of the display discharge drive, both the light-on cell and the light-off cell can be restored to the state (threshold voltage level) immediately be fore the address discharge drive.

Further, in the drive method shown in FIG. 7, the aforementioned waveforms are applied to the X electrode and the Y electrode. However, since it is sufficient if an X-Y voltage capable of realizing such the operation as described above is applied, it is possible to properly deform to any other waveform.

Referring back to FIG. 6, a drive waveform to weight a luminance value will be explained. In each subframe period SF1-SF3, by changing the final voltages V1, V2, V3 of the Y voltage Vy in the first-half display discharge drive DIS, it is possible to vary a discharge scale in the display discharge DS3. Other display discharges DS4, DS5 are discharges necessary for reset, and the discharge scale thereof is controlled to an equivalent order. Then, by selecting a light-on cell in the address discharge drive ADD in each subframe period, it is possible to display desired gray scales by combining the weighted luminance values. Since the final voltages are set to X1:X2:X3=4:2:1, eight gray scales can be displayed by combining the subframes.

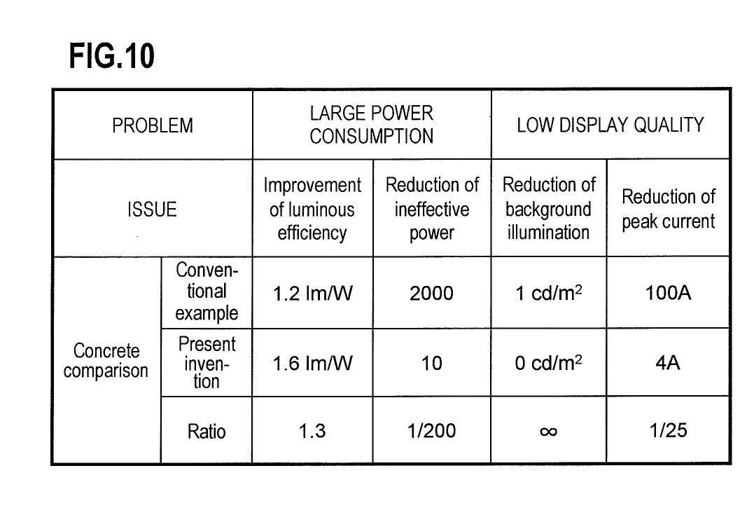

FIG. 10 shows a table in which an embodiment of the display discharge drive, using ramp-wave discharge with the drive waveform shown in FIG. 7, is compared with an example of the display discharge drive according to the conventional drive method, using strong discharge. There are shown luminous efficiency and ineffective power, luminance of background illumination and peak current value, in regard to the examples of the prior art and the present invention. The luminous efficiency has been improved approximately 1.3 times, as well as the ineffective power reduced to 1/200 and the background illumination improved to infinite, because of the removal of the background illumination due to the reset discharge of the entire panel surface, and also, the peak power current has been reduced to 1/25.

As described above, according to the present embodiment, the drive circuit in the PDP device performs both the address discharge drive and the display discharge drive, and in the display discharge drive, the display discharge pulse having a gradually increasing voltage to the extent of enabling the ramp-wave discharge is applied to the sustain electrode (X electrode or Y electrode). With this, the luminous efficiency is improved with reduced ineffective power, and the reset discharge of the entire panel surface is removed and also the background illumination is removed, and it becomes possible to reduce the peak current at the time of discharge, and the streaking phenomenon.

### INDUSTRIAL APPLICABILITY

According to the present invention, it is possible to reduce power consumption, background illumination, and the streaking phenomenon.

What is claimed is:

1. A plasma display device performing display control by utilizing plasma discharge, comprising:
a panel including a plurality of address electrodes and a plurality of display electrodes disposed to intersect with the address electrodes; and
a drive circuit performing address discharge drive for selectively producing a discharge in cells between the address electrodes and the display electrodes, and display discharge drive for applying to the display electrode a display drive pulse having a voltage increasing with such a gradient as to continuously produce a discharge current in the selected cell.

2. A plasma display device performing display control by utilizing plasma discharge, comprising:
a panel including a plurality of address electrodes and a plurality of display electrodes disposed to intersect with the address electrodes; and
a drive circuit performing address discharge drive for selectively producing a discharge in cells between the address electrodes and the display electrodes, and display discharge drive for applying to the display electrode a display drive pulse having a voltage increasing with such a gradient as to continuously produce faint discharges in the selected cell.

3. The plasma display device according to claim 1 or 2,
wherein the display panel comprises a first display electrode and a second display electrode disposed mutually adjacently, as display electrodes, and
wherein, in the address discharge drive, the drive circuit applies an address voltage to the address electrode, while successively driving one of the first and the second display electrodes.

4. The plasma display device according to claim 1 or 2,
wherein the display panel comprises a first display electrode and a second display electrode disposed mutually adjacently, as display electrodes, and
wherein, in the display discharge drive, the drive circuit performs a first display discharge drive for applying the display drive pulse between the first and the second display electrodes, and performs a second display discharge drive for applying the display drive pulse between the first or the second display electrode and the address electrode.

5. The plasma display device according to claim 1 or 2,
wherein the drive circuit performs the address discharge drive and the display discharge drive subsequent thereto, repeatedly for a plurality of times.

6. The plasma display device according to claim 1 or 2,
wherein the drive circuit performs the address discharge drive and the display discharge drive subsequent thereto, repeatedly for a plurality of times, and
wherein a final voltage value of the display drive pulse in each display discharge drive is weighted by a predetermined ratio.

7. The plasma display device according to claim 1 or 2,
wherein the voltage to be applied to the display electrode in the display discharge drive following the address discharge drive is a unipolar display discharge pulse.

8. The plasma display device according to claim 1 or 2,
wherein, further, the drive circuit is a circuit applying a single of the display discharge pulse in the display discharge drive period.

9. A plasma display device performing display control by utilizing plasma discharge, comprising:
a panel including a plurality of address electrodes and a plurality of display electrodes disposed to intersect with the address electrodes; and
a drive circuit performing address discharge drive for selectively producing a discharge in cells between the address electrodes and the display electrodes, and display discharge drive for applying to the display electrode a display drive pulse having a voltage increasing with such a gradient as to continuously produce a discharge current in the selected cell,
wherein, further, in a frame period, there are included a plurality of subframe periods in which the address discharge drive and one-time display discharge drive subsequent thereto are performed, respectively, and in each of the plurality of subframe periods, the drive circuit selects a light-on cell by the address discharge drive, so as to control the luminance value of each cell in the frame period.

10. The plasma display device according to claim 9,
wherein the drive circuit weights the gradient in each display discharge drive by a predetermined ratio.

11. The plasma display device according to claim 9,
wherein the display panel includes a first display electrode and a second display electrode disposed mutually adjacently, as display electrodes, and
wherein, in the address discharge drive, the drive circuit applies an address voltage to the address electrode, while successively driving one of the first and the second display electrodes.

12. The plasma display device according to claim 9,
wherein the display panel includes a first display electrode and a second display electrode disposed mutually adjacently, as display electrodes, and
wherein, in the display discharge drive, the drive circuit performs a first display discharge drive for applying the display drive pulse between the first and the second display electrodes, and performs a second display discharge drive for applying the display drive pulse between the first or the second display electrode and the address electrode.
